(19) United States
(12) Patent Application Publication
(10) Pub. No.: US 2005/0177828 A1
(43) Pub. Date: Aug. 11, 2005

(54) Restore media build automation

(76) Inventors: Christoph J. Graham, Houston, TX (US); Yongmei Hua, Cypress, TX (US); Adrian Patschke, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/772,682

(22) Filed: Feb. 5, 2004

(51) Int. Cl. G06F 9/445

(52) U.S. Cl. 717/175; 714/15

(57) ABSTRACT

Systems, methodologies, media, and other embodiments associated with automatically building a restore media that stores a restore distribution are described. One exemplary system embodiment includes a data store in which restore distribution building blocks and/or rules concerning those building blocks are stored. The example system may also include a build logic for combining building blocks into a restore distribution based, at least in part, on the rules concerning the building blocks. The example system may also include a media creator configured to store a restore distribution on a computer-readable medium.

### BACKGROUND

Installing software on a computer can be a difficult task, particularly for a consumer. Thus, intelligent methods for installing software on a computer have appeared. These intelligent media and/or software packages can analyze a computer at installation time and determine what software to install. However, these methods and/or media produced by the methods may conventionally be manually produced from a variety of components using a variety of processes.

Installed software may need to be restored. For example, software components like an operating system component, an application, a device driver, a file system component, and so on may be corrupted, causing the installed software to not function properly. Thus, a restore media (e.g., CD) configured to restore the installed software to its original state may be hand-crafted and provided to the user whose computer is malfunctioning. Many items (e.g., drivers, data structures, applications, operating system components, file system components), may be placed on the restore media, along with computer executable instructions for determining issues like what has to be restored, how it should be restored, and the like. However, like the install media described above, these restore media may be manually produced from a variety of components using a variety of processes.

Hand-crafting a restore media (e.g., CD) may include an engineer performing manual activities involving disparate tools that acquire data from a variety of locations using a variety of methods. The manual activities (e.g., data entry) may be prone to typographic errors, syntax errors, omissions, and the like. Additionally, there may be no cohesion between the manual activities, and thus steps may be omitted, performed in the wrong order, be difficult to recreate, be difficult to document (e.g., for training purposes) and so on. Furthermore, these manual processes typically have little, if any, capability concerning tracking a project history. Tracking, if performed at all, may consist of making an entry in a hand-written log. Thus, it has conventionally been difficult, if possible at all, to transfer build environments from machine to machine, to train new employees in the restore media build process, and so on.

Even with the shortcomings described above, conventional systems and methods may still produce a useful intelligent and/or unintelligent restore media. An unintelligent restore media may include a single software image for a particular platform. Since target platforms may vary, an organization providing unintelligent restore CDs may maintain an extensive catalog of restore CDs. To facilitate reasonable response time to consumer demands, the organization may also keep an inventory of some “standard” restore media. An intelligent restore media may include software components for a variety of platforms and intelligence (e.g., processor executable instructions, processor readable data) concerning how to create a customized software image after analyzing the target platform. Thus, a smaller set of restore CDs may be maintained in the catalog. However, an inventory may still be maintained.

An intelligent restore CD may include building blocks that can be combined on-the-fly at restore time after detecting the hardware and/or software environment for which the restore is to be performed. The intelligent restore CD may also include rules for how to combine various building blocks based on platform parameters like hardware, software, region, use (e.g., games, server, office productivity), user (e.g., programmer, gamer, secretary), and the like.

Manually producing restore CDs produces issues similar to those associated with manually producing install CDs. For example, it may be difficult to track what restore CDs have been produced, to recreate a particular restore CD, to be accurate and complete when constructing a restore CD, to produce a large volume of restore CDs in a cost-effective, timely manner, and so on. Furthermore, even though intelligent restore CDs may be able to build more than one image, the organization providing the intelligent CDs may still be required to maintain a catalog and inventory of intelligent restore CDs.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example system for automatically building a restore media.

FIG. 2 illustrates another example system for automatically building a restore media.

FIG. 3 illustrates another example system for automatically building a restore media.

FIG. 4 illustrates an example method for automatically building a superset of data from which a restore distribution can be built.

FIG. 5 illustrates an example method for automatically building a restore media.

FIG. 6 illustrates an example application programming interface (API) associated with automatically building a restore media.

### DETAILED DESCRIPTION

Example systems and methods described herein concern automating the building of a restore media (e.g., a CD). A restore media is a computer-readable medium that stores a restore distribution. An organization (e.g., software manufacturer, software provider) may have an inventory of hundreds or thousands of software and/or data components from which a software image is built. The software and/or data components may be referred to as “building blocks”, since a software image may be constructed from these smaller parts. In theory, if there was a single computer-readable medium with an infinite capacity, every building block, and programs for combing the building blocks into a desired image, could be stored on that single media. However, for security, trade secret, and other reasons, this theoretical computer-readable medium might not be built. Furthermore, since some building blocks may never be used together, it might not make sense to store them on a single computer-readable medium from which a software image could be built. Thus, a smaller set of building blocks and programs or computer executable instructions for producing a software image on a target platform from the building blocks may be built. This set of building blocks and intelligence (e.g., computer executable instructions, computer-readable data) may be referred to as a “restore distribution”.

Example systems and methods facilitate producing more accurate deliverables, more accurately tracking deliverable content and properties, producing the deliverables in a more timely manner, and/or producing accurate release information about builds including delta information between builds. In one example, an automated restore media build process and/or method can perform batch and/or scheduled operations to facilitate increasing restore media build throughput and decreasing build time. In another example, an automated restore media build process and/or method facilitates testing restore media building and applying computerized data integrity tools to monitor building a restore media.

Example systems and methods described herein may produce an intelligent restore CD. The intelligent restore CD may include a collection of building blocks, intelligence (e.g., computer executable instructions, computer-readable data) for processing the building blocks, and so on. The building blocks may be acquired by automated systems and methods from a building block data store (e.g., database, software repository). Similarly, the intelligence may be acquired from an intelligence data store (e.g., rules database). Which building blocks and/or intelligence to store on the intelligent restore CD may be affected, at least in part, by metadata (e.g., attributes) about the building blocks stored, for example, in a metadata data store (e.g., database). The metadata data store may store, for example, build lists for related sets of building blocks, dependencies between building blocks, rules required to restore a software image, and the like. The automated systems and methods may thus reference various data stores to acquire the content for the intelligent restore CD. The automated systems and methods may also access data concerning constraints related to building an image.

In one example, an automated build process and apparatus may acquire the content for the intelligent restore CD, acquire metadata about the content for the intelligent restore CD, acquire constraint information concerning building a restore image, and then control a CD burner to produce an intelligent restore CD that stores a restore distribution crafted from the content and the rules. While a restore CD is described, it is to be appreciated that other media like a floppy disk, a memory card, a USB token, a DVD, and the like may be built by the example systems and methods. In one example, the automated build process and apparatus produce tracking data that facilitates tracking the build process, recreating a built CD, monitoring throughput, and the like.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

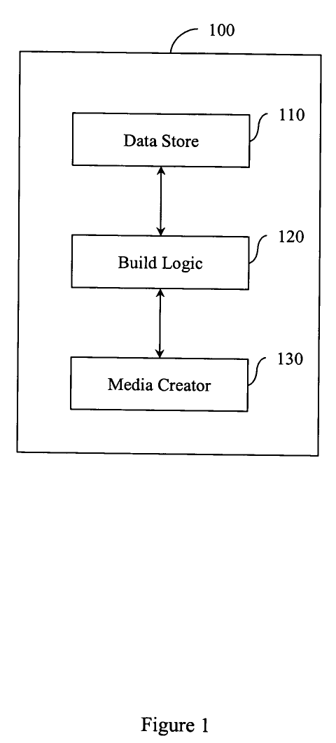

FIG. 1 illustrates an example system 100 for automatically building a restore media. The system 100 may include a data store 110 that is configured to store a building block. A building block may be, for example, a file, a program, an application, an object, a dynamic link library, a data structure definition, a data structure, a file system definition, a file system, an applet, a servlet, a subroutine, a database record, a database, a device driver, an operating system service pack, a quick fix engineering component (e.g., bug fix), and the like. A restore distribution may be built partially and/or completely from building blocks. The data store 110 may also store build information concerning building blocks. The build information may include, for example, rules, heuristics, programs, build lists, build definitions, dependencies, executables, and the like. The build information may facilitate controlling how the building blocks are processed into the build distribution.

The system 100 may also include a build logic 120 that is operably connectable to the data store 110. The build logic 120 may be configured to selectively read the build information and, in response to analyzing the build information, to selectively read a building block from the data store 110. For example, the build information may indicate that a certain set of building blocks are required to build a restore distribution. Thus, based on the build information, that set of building blocks may be read from the restore distribution. The build logic 120 may also be configured to create the restore distribution from building blocks based, at least in part, on the build information. As described above, a restore distribution can be employed to produce a software image on a target platform. In one example, the restore distribution can automatically produce the software image on the target platform and thus may include computer executable instructions for producing the software image from the restore distribution.

The build information may be stored as attributes. These attributes may describe, for example, information concerning an operating system associated with a building block, an operating system version associated with a building block, a spoken language associated with a building block, a computer language associated with a building block, a region in which a building block functions, a device identifier for a device with which a building block may function, a release data associated with a building block, an architecture with which a building block functions, and the like. Thus, the attributes may also facilitate controlling how the building blocks are processed into and/or out of the restore distribution.

In one example, the system 100 may include a media creator 130 configured to store the restore distribution on a computer-readable medium. Thus, the build logic 120 may be further configured to control the media creator 130 to store the restore distribution on the computer-readable medium. Controlling the media creator 130 may include, for example, sending a signal to the media creator 130 to write the restore distribution to a computer-readable medium. The media creator 130 may be configured to store the restore distribution on a computer-readable medium like a compact disc (CD), a digital versatile disk (DVD), a tape, a floppy disk, a Zip disk, an application specific integrated circuit, a memory stick, a memory, a USB token, and so on. Thus, in one example, the media creator 130 is a CD burner.

In one example, a restore distribution includes content elements that are derived from building blocks. For example, deriving a content element from a building block may include copying the building block, compiling the building block to produce an executable, interpreting the building block to produce an executable, assembling the building block to produce an executable, translating the building block, and the like. Since a content element is derived from a building block, a content element may be, for example, a file, a program, an application, an object, a dynamic link library, a data structure definition, a data structure, a file system definition, a file system, an applet, a servlet, a subroutine, a database record, and a database. In addition to content elements, a restore distribution may include rules for combining content elements, a program(s) for installing content elements onto a target platform, a program(s) for combining content elements into portions of a software image, computer executable instructions for analyzing (“touching”) the target platform to discover hardware, software, and/or firmware configurations, and the like.

In one example, the build logic 120 is configured to store, in the data store 110, information about building the restore distribution and/or information about building a software image. Thus, information may be fed back from the media creator 130 to the build logic 120. This information may describe how long it took to build the computer-readable medium, whether the build was successful, the size of the restore distribution, and the like. Similarly, the restore media and/or the target platform may report back to the build logic 120 concerning the restore.

To facilitate building a restore distribution, and thus a restore media, an organization may locate, organize, produce, index, and so on, the building blocks from which a software image can be built. This collection of building blocks may be referred to as a “superset” of build data. The organization may also locate, organize, produce, index, and so on rules concerning how to process the building blocks. These rules may be added to the superset. Then, a restore distribution can be produced from the superset by selecting a subset of the building blocks and/or rules, selectively processing (e.g., compiling, linking) the building blocks, and storing them on a computer-readable medium.

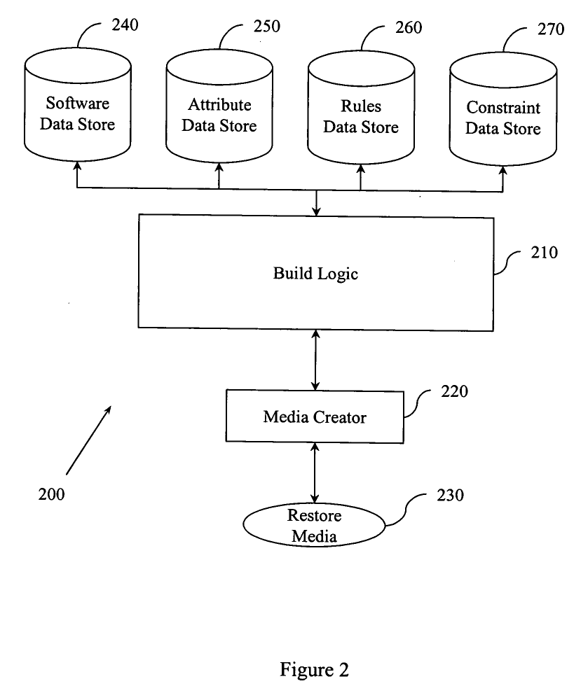

FIG. 2 illustrates an example system 200 for automatically building a restore media 230. One example system 200 includes a build logic 210 that collects information from a variety of sources then controls a media creator 220 to produce the restore media 230. The example system 200 includes a software data store 240 into which building blocks for building a software image can be collected. The software data store 240 facilitates accessing building blocks when the restore distribution is produced, referred to as “restore distribution build time”. Similarly, the time when the restore distribution is employed to produce a software image on a target platform is referred to as “restore time”. The system 200 may also include an attribute data store 250 for storing data concerning the building blocks. The attribute data store 250 facilitates accessing information at restore distribution build time for selecting building blocks to include in a restore distribution. The building block attributes can include build lists, known interactions between building blocks, desired interactions between building blocks, dependencies between building blocks, and the like. The system 200 may also include a rules data store 260 for storing data concerning how various building blocks may be combined. The rules data store 260 facilitates storing rules that may control how the building blocks are combined at restore time, and thus rules may be acquired from the rules data store 260 and deposited on the restore media. The example system 200 may also include a constraint data store 270. The constraint data store 270 facilitates storing constraints concerning the scope of coverage for a restore distribution and/or when to exclude a building block from a restore distribution. While four separate data stores are illustrated, it is to be appreciated that the four data stores could be distributed between a greater number of data stores and/or collected in a smaller number of data stores.

Thus, in one example, the system 200 includes a software data store 240 that is configured to store a building block that may be included in a restore distribution. A building block may be a file, a program, an application, an object, a dynamic link library, a data structure definition, a data structure, a file system definition, a file system, an applet, a servlet, a subroutine, a database record, a database, and the like.

The system 200 may also include an attribute data store 250 that is configured to store an attribute related to a building block stored in the software data store 240. An attribute may store information like an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, and a dependency between two or more building blocks. By way of illustration, there may be four building blocks available to support converting a first data format to a second data format. A first operating system may process both data formats, but a second operating system may process neither data format. Thus, an attribute associated with a building block may identify operating systems for which the building block is required and operating systems to which the building block is substantially useless. If the build logic 210 has information concerning the operating system on the target platform, then the attribute may be used to selectively read a desired building block(s) from the software data store 240 to facilitate producing a restore media with an adequate and/or desired coverage. In some cases, to facilitate reducing the catalog of restore media, the building blocks may be included in the restore distribution regardless of whether they can be used to produce a particular software image. In this way a more general restore media that can produce a variety of software images can be produced.

The system 200 may also include a rules data store 260 that is configured to store a rule. A rule may be implemented as computer executable instructions and/or data. A rule may facilitate controlling, for example, whether a building block is included in a restore distribution, how to process (e.g., compile, link, interpret) a building block at restore distribution build time, how to process a building block at restore time, and so on. A rule set may include rules that facilitate deciding when to include a building block on a media. A rule set may also include rules that facilitate deciding how to combine building blocks (e.g., order, connections, dependencies). A rule set may include data concerning limiting a building block at restore time. For example, a rule may determine that if a first operating system is present in the restore environment then a first building block may be employed in building a software image for the restore environment but if a second operating system is present, then a second building block may be employed instead of the first building block. A rule may be employed by restore software at restore time to control what the restore software does after the restore media is associated with (e.g., boots) the target platform. A rule may control the order in which building blocks are installed and combined, may control how building blocks are connected, and so on. A rule set may be compiled from conventional/historic build definitions that may include handwritten notes, computer programs, scripts, personal knowledge, and so on. Thus, a rule may describe how a building block is to be selected for inclusion in a restore distribution, how to combine two or more building blocks, how to connect two or more building blocks, when a building block is to be processed at restore distribution build time, how a building block is to be processed at restore distribution build time, when a building block is to be processed at restore time, how a building block is to be processed at restore time, and so on.

The system 200 may also include a constraint data store 270 that is configured to store a constraint. A constraint may facilitate establishing a scope of the restore distribution. A constraint may be applied when building the restore media 230. For example, a first block (e.g., RSA encryption block) may be employed inside the continental United States while a second block (e.g., PGP encryption block) may be employed outside the continental United States to comply with federal regulations concerning exporting encryption algorithms.

The system 200 may also include a build logic 210 that is configured to read building blocks from the software data store 240, to read attributes from the attribute data store 250, to read rules from the rules data store 260, to read constraints from the constraint data store 270, and so on. After acquiring this rich set of data, the build logic 210 may build a restore distribution that includes a building block, a rule and so on. How the build logic 210 processes the building blocks into the restore distribution may be controlled, at least in part, by rules and/or constraints. The build logic 210 may, for example, have building blocks copied to the restore distribution, compiled into executables and then copied to the restore distribution, compressed and/or decompressed and then copied to the restore distribution, and so on.

In one example, the system 200 may include a media creator 220 that is configured to store the restore distribution on a computer-readable medium. The media creator 220 may be configured to store the restore distribution on computer-readable mediums like a compact disc (CD), a digital versatile disk (DVD), a tape, a floppy disk, a Zip disk, an application specific integrated circuit, a memory stick, a memory, a Universal Serial Bus (USB) token, and the like.

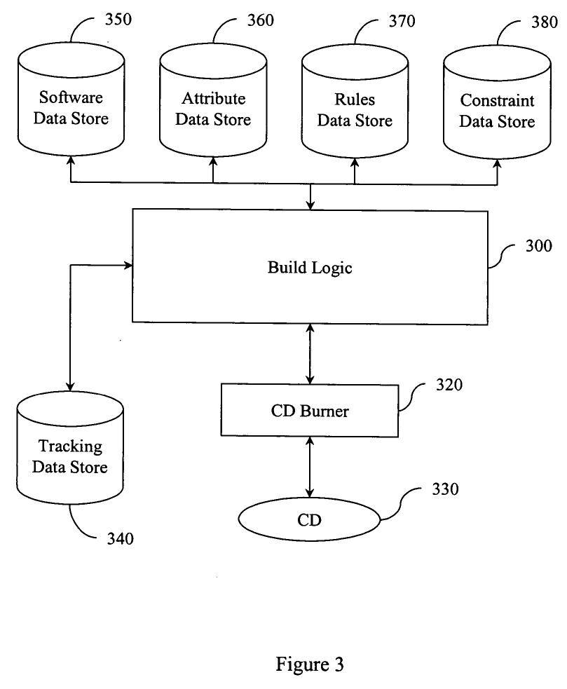

FIG. 3 illustrates another example system for automatically building a restore media. The system facilitates producing a restore CD 330 in an ISO image from which a restore can be performed. The restore CD 330 may include a restore distribution that includes, for example, building blocks, building block attributes, processes to “touch the platform”, (e.g., detect installed hardware, software) and to build the software image just-in-time on the platform being restored. The restore CD 330 may be built in a manner that facilitates using the restore CD 330 to perform a restore (e.g., produce a software image) on a variety of target platforms, thus reducing the number of restore CDs in the catalog. While a restore CD could be built to cover substantially every possible platform that may require restoration, a more compact coverage may be desired. Therefore, the system may facilitate producing a master set of data and intelligence (e.g., a superset) and then applying constraint data to produce a restore distribution with less than the theoretically substantially complete coverage possible and store it on restore CD.

The system is substantially similar to the system 200, except that the media creator is a CD burner 320. In addition to the components similar to those in system 200, the CD burner 320 may be configured to send a signal to the build logic 300 that the CD burner 320 completed storing a restore distribution on CD 330.

The system may also include a tracking data store 340 that is configured to store information like restore distribution build times, restore distribution build completion rates, whether a particular restore distribution build was completed, and so on. Thus, the build logic 300 may be configured to store status data concerning restore distributions. The build logic 300 may store the status data in the tracking data store 340. In one example, the build logic 300 may store the data upon receiving a signal from the CD burner 320 that the restore distribution has been successfully stored.

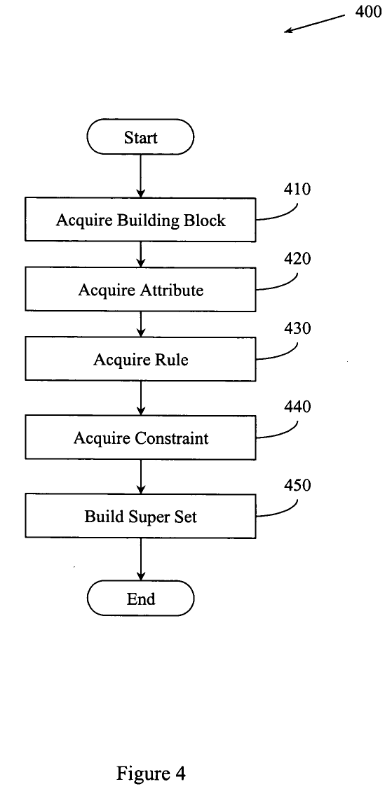

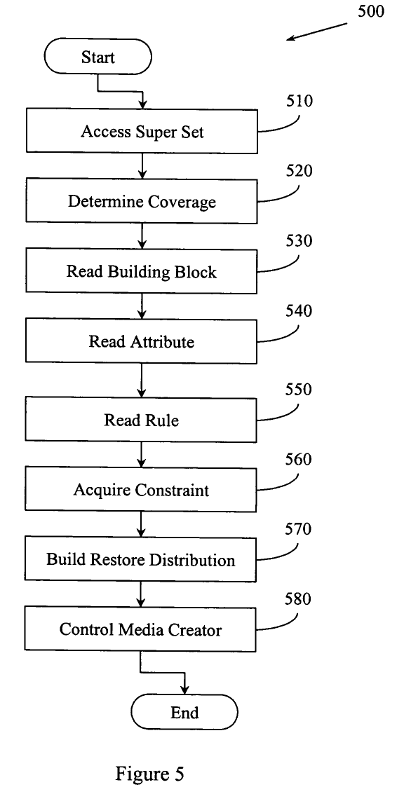

Example methods may be better appreciated with reference to the flow diagrams of FIGS. 4 and 5. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 4 illustrates an example method 400 for automatically building a superset of data from which a restore distribution can be built. The superset of data may include components from which a restore distribution can be built and data or instructions concerning how to build a software image and/or restore distribution from the components. Thus, the method 400 may include, at 410, acquiring a building block. The building block may be included in a restore distribution after being added to the superset and/or may be processed into a content element that is stored in a restore distribution. After acquiring the building block the method 400 may store the building block in a data store (e.g., database) to facilitate retrieving it and building the superset.

The method 400 may also include, at 420, acquiring an attribute concerning the building block. After acquiring the attribute, it may be related to the building block and stored in a data store. The method 400 may also include, at 430, acquiring a rule(s) concerning issues like when to include a building block in a restore distribution, how to process (e.g., compile, link, connect) a building block at restore distribution build time, how to process a building block at restore time, and the like. The rule may be stored in a rule data store. Similarly, the method 400 may include, at 440, acquiring a constraint concerning issues like how to limit a scope of a restore distribution, when to exclude a building block from a restore distribution, and so on. The constraint may be stored in a constraint data store. Thus, the actions described from 420 through 440 concern acquiring information about the building blocks acquired at 410 and information about how to process those building blocks.

With the information collected and analyzed, the method 400 may then proceed, at 450, to build a restore distribution superset from the building blocks, the attributes, the rules, and the constraints. The restore distribution superset may then be stored, for example, in a database. It is to be appreciated that a restore distribution may be built from a subset of the elements of the restore distribution superset. Although a subset of elements may be employed, the subset may still include a superset of elements required to produce a particular software image. Thus, the number of restore media maintained in a organization's catalog may be reduced. It is to be appreciated that the superset is not a mere compilation of data but rather is a data structure stored in a computer readable form in a data store and/or on a computer readable medium.

While FIG. 4 illustrates various actions occurring in serial, it is to be appreciated that various actions illustrated in FIG. 4 could occur substantially in parallel. By way of illustration, a first process could acquire building blocks. Similarly, a second process could acquire attributes, while a third process could acquire rules and constraints and a fourth process could build and store the superset. While four processes are described, it is to be appreciated that a greater and/or lesser number of processes could be employed and that lightweight processes, regular processes, threads, and other approaches could be employed.

FIG. 5 illustrates an example method 500 for automatically building a restore media. The method 500 may include, at 510, accessing a superset of restore distribution elements. The superset may be similar to a superset built by a method like method 400. Accessing the superset may include, for example, establishing a logical and/or physical connection with a data store in which the superset is stored. For example, accessing the superset may include logging into a database.

The method 500 may also include, at 520, determining a desired coverage for a restore distribution to be built from restore distribution elements located in the superset. This coverage may be determined by, for example, examining information concerning a set of target platforms, a set of software images that may need to be built, marketing concerns, security concerns, media storage capacity, and so on. The information may be available electronically and/or may by provided by a user interacting with a graphical user interface.

The method 500 may also include, at 530, selectively reading, from the superset, a building block. Which building blocks are read may be controlled, at least in part, by the desired coverage. For example, a more expansive coverage may lead to more building blocks being read while a more restricted coverage may lead to less building blocks being read. A building block may include, for example, a file, a program, an application, an object, a dynamic link library, a data structure definition, a data structure, a file system definition, a file system, an applet, a servlet, a subroutine, a database record, a database, and the like.

After a building block has been read, the method 500 may seek to acquire more information about the building block. Thus, the method 500 may include, at 540, reading, from the superset, an attribute concerning the building block. The attribute may describe, for example, an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, a dependency between two or more building blocks, and so on. Having acquired some information about the building block the method 500 may still seek more information about the building block and/or a restore distribution to be built from the building blocks.

Thus, the method 500 may include, at 550, reading, from the superset, a rule concerning issues like how to process the building block into the restore distribution at restore distribution build time, and how to process the building block at restore time. For example, a rule may describe how a building block is to be selected for inclusion in a restore distribution, how to combine two or more building blocks, how to connect two or more building blocks, when a building block is to be processed at restore distribution build time, how a building block is to be processed at restore distribution build time, when a building block is to be processed at restore time, how a building block is to be processed at restore time, and the like.

The method 500 may also include, at 560, acquiring a constraint. The constraint may describe, for example, how the building block is to be limited in a software image built on a target platform from the restore distribution, and so on. The constraint may be acquired from a human operator (e.g., software engineer), a process (e.g., artificial intelligence monitor), read from a data store (e.g., file) and so on.

With the information concerning building blocks and how to process them collected, the method 500 may include, at 570, building a restore distribution. The restore distribution may include, for example, building blocks, components derived from building blocks, computer executable instructions for building a software image, computer-readable data for building a software image, and so on. Therefore, building the restore distribution may include copy building blocks to the restore distribution, compiling a building block into an object code and storing the object code in the restore distribution and so on. The method 500 may also include, at 580, controlling a media creator to store the restore distribution on a computer-readable medium. For example, the method 500 may send a data packet describing the location of the restore distribution, a desired build time, and other information to the media creator. Then, the method 500 may receive, (not illustrated), from the computer-readable media creator, a signal and/or a tracking data concerning how and/or whether the restore distribution was stored on the computer-readable medium.

While FIG. 5 illustrates various actions occurring in serial, it is to be appreciated that various actions illustrated in FIG. 5 could occur substantially in parallel. By way of illustration, a first process could access the superset and determine a desired coverage, a second process could read building blocks, attributes, and rules, a third process could acquire constraints, a fourth process could build the restore distribution, and a fifth process could control the media creator to store the restore distribution on a computer-readable medium. While five processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, a computer-readable medium may store processor executable instructions operable to perform a method that includes acquiring a building block that may be included in a restore distribution and storing the building block in a building block data store. The building block may be a file, a program, an application, an object, a dynamic link library, a data structure definition, a data structure, a file system definition, a file system, an applet, a servlet, a subroutine, a database, and so on. The method may also include acquiring an attribute concerning the building block, relating the attribute to the building block, and storing the attribute in an attribute data store. The method may also include acquiring a rule concerning when to include a building block in a restore distribution, how to process a building block at restore distribution build time, how to process a building block at restore time, and so on. The method may also include acquiring a constraint concerning how to limit the scope of the restore distribution, when to exclude a building block from the restore distribution, and the like. The method may also include building a restore distribution superset from the building blocks, the attributes, the rules, and/or the constraints. The restore distribution can be built from a subset of the elements of the restore distribution superset. While the above method is described being stored on a computer-readable medium, it is to be appreciated that other example methods described herein can also be stored on a computer-readable medium.

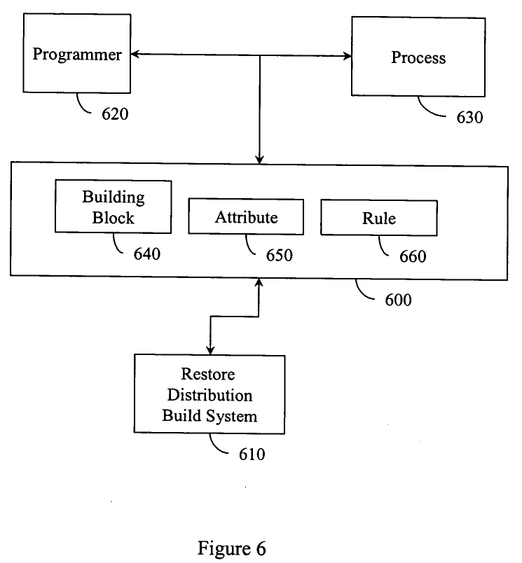

Referring now to FIG. 6, an application programming interface (API) 600 is illustrated providing access to a computerized system 610 for automatically building a restore media. The API 600 can be employed, for example, by a programmer 620 and/or a process 630 to gain access to processing performed by the system 610. For example, a programmer 620 can write a program to access the system 610 (e.g., invoke its operation, monitor its operation, control its operation) where writing the program is facilitated by the presence of the API 600. Rather than programmer 620 having to understand the internals of the system 610, the programmer 620 merely has to learn the interface to the system 610. This facilitates encapsulating the functionality of the system 610 while exposing that functionality.

Similarly, the API 600 can be employed to provide data values to the system 610 and/or retrieve data values from the system 610. For example, a process 630 that processes building blocks can provide a building block to the system 610 via the API 600 by, for example, using a call provided in the API 600. Thus, in one example of the API 600, a set of application programming interfaces can be stored on a computer-readable medium. The interfaces can be employed by a programmer, computer component, process, logic, and so on to gain access to a system 600 for automatically producing a restore distribution. The interfaces can include, but are not limited to, a first interface 640 that communicates a building block that may be included in a restore distribution, a second interface 650 that communicates an attribute concerning a building block, and a third interface 660 that communicates a rule concerning how to process a building block into a restore distribution and/or how to process a building block out of a restore distribution and into a software image on a target platform.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A system, comprising:
a data store configured to store a building block from which a restore distribution can be built, and a build information concerning the building block; and
a build logic operably connectable to the data store, the build logic being configured to selectively read the build information and, in response to analyzing the build information, to selectively read a building block, and to create the restore distribution from one or more building blocks based, at least in part, on the build information, where the restore distribution is configured to automatically produce a software image on a target platform and the restore distribution includes computer executable instructions for producing the software image from the restore distribution.

2. The system of claim 1, including a media creator configured to store the restore distribution on a computer-readable medium, and where the build logic is further configured to control the media creator to store the restore distribution on the computer-readable medium.

3. The system of claim 1, where a building block comprises one or more of, a file, a program, an application, an object, a dynamic link library, a data structure definition, a data structure, a file system definition, a file system, an applet, a servlet, a subroutine, a database record, and a database.

4. The system of claim 1, where the build information includes one or more of, a rule, a heuristic, a program, a build list, a build definition, a dependency, and an executable.

5. The system of claim 2, the media creator being configured to store the restore distribution on one or more of, a compact disc (CD), a digital versatile disk (DVD), a tape, a floppy disk, a Zip disk, an application specific integrated circuit, a memory stick, a memory, and a USB token.

6. The system of claim 2, where the media creator comprises a CD burner.

7. The system of claim 1, where the restore distribution includes a content element derived from a building block, where deriving the content element from the building block includes one or more of, copying, compiling, interpreting, assembling, and translating the building block.

8. The system of claim 7, where the content element comprises one or more of, a file, a program, an application, an object, a dynamic link library, a data structure definition, a data structure, a file system definition, a file system, an applet, a servlet, a subroutine, a database record, and a database.

9. The system of claim 8, where the restore distribution includes one or more of, a rule for combining one or more content elements, a program for installing one or more content elements, a program for combining one or more content elements, and computer executable instructions configured to analyze the target platform on which the software image will be built from the restore distribution.

10. The system of claim 1, where the build logic is further configured to store, in the data store, information concerning one or more of, a restore distribution build, and a software image build.

11. A system, comprising:
a software data store configured to store a building block that may be included in a restore distribution;
an attribute data store configured to store an attribute related to a building block stored in the software data store;
a rules data store configured to store a rule that facilitates controlling one or more of, including a building block in a restore distribution, processing a building block at restore distribution build time, and processing a building block at restore time;
a constraint data store configured to store a constraint that facilitates establishing a scope of the restore distribution; and
a build logic configured to read one or more building blocks from the software data store, to read one or more attributes from the attribute data store, to read one or more rules from the rules data store, to read one or more constraints from the constraint data store, and to build a restore distribution that includes one or more of, a building block, and a rule, where the build logic may be controlled, at least in part, by a rule and a constraint,
where the restore distribution also includes computer executable instructions related to producing, from the restore distribution, a software image on a target platform.

12. The system of claim 11, including a media creator configured to store the restore distribution on a computer-readable medium.

13. The system of claim 11, where a building block comprises one or more of, a file, a program, an application, an object, a dynamic link library, a data structure definition, a data structure, a file system definition, a file system, an applet, a servlet, a subroutine, a database record, and a database.

14. The system of claim 11, where an attribute is configured to store information concerning one or more of, an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, and a dependency between two or more building blocks.

15. The system of claim 11, where a rule describes one or more of, how a building block is to be selected for inclusion in a restore distribution, how to combine two or more building blocks, how to connect two or more building blocks, when a building block is to be processed at restore distribution build time, how a building block is to be processed at restore distribution build time, when a building block is to be processed at restore time, and how a building block is to be processed at restore time.

16. The system of claim 11, where a constraint describes one or more of, how to limit a scope of a restore distribution, and when to exclude a building block from a restore distribution.

17. The system of claim 11, the media creator being configured to store the restore distribution on one or more of, a compact disc (CD), a digital versatile disk (DVD), a tape, a floppy disk, a Zip disk, an application specific integrated circuit, a memory stick, a memory, and a Universal Serial Bus (USB) token.

18. The system of claim 11, where the media creator comprises a CD burner.

19. The system of claim 11, the media creator being configured to send a signal to the build logic that storing a restore distribution on a computer-readable medium has completed.

20. The system of claim 19, including a tracking data store, and where the build logic is configured to store in the tracking data store, upon receiving the signal, a status data concerning the restore distribution.

21. A method, comprising:
acquiring a building block that may be included in a restore distribution;
acquiring an attribute concerning the building block, and relating the attribute to the building block;
acquiring a rule concerning one or more of, when to include a building block in a restore distribution, how to process a building block at restore distribution build time, and how to process a building block at restore time;
acquiring a constraint concerning one or more of, how to limit a scope of a restore distribution, and when to exclude a building block from a restore distribution; and
building a restore distribution superset from one or more of, the building block, the attribute, the rule, and the constraint, where a restore distribution can be built from a subset of the elements of the restore distribution superset.

22. The method of claim 21, including storing the building block in a building block data store.

23. The method of claim 22, including storing the attribute in an attribute data store.

24. The method of claim 23, including storing the rule in a rules data store.

25. The method of claim 24, including storing the constraint in a constraint data store.

26. The method of claim 25, where the restore distribution superset is stored in a database.

27. The method of claim 21, where a building block comprises one or more of, a file, a program, an application, an object, a dynamic link library, a data structure definition, a data structure, a file system definition, a file system, an applet, a servlet, a subroutine, a database record, and a database.

28. The method of claim 21, where an attribute is configured to store information concerning one or more of, an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, and a dependency between two or more building blocks.

29. The method of claim 21, where a rule describes one or more of, how a building block is to be selected for inclusion in a restore distribution, how to combine two or more building blocks, how to connect two or more building blocks, when building blocks are to be processed at restore distribution build time, how building blocks are to be processed at restore distribution build time, when building blocks are to be processed at restore time, and how building blocks are to be processed at restore time.

30. The method of claim 21, where a constraint describes one or more of, how to limit the scope of a restore distribution, and when to exclude a building block from a restore distribution.

31. A computer-readable medium storing computer executable instructions operable to perform a method, the method comprising:
acquiring a building block that may be included in a restore distribution and storing the building block in a building block data store, the building block comprising one or more of, a file, a program, an application, an object, a dynamic link library, a data structure definition, a data structure, a file system definition, a file system, an applet, a servlet, a subroutine, a database record, and a database;
acquiring an attribute concerning the building block, relating the attribute to the building block, and storing the attribute in an attribute data store;
acquiring a rule concerning one or more of, when to include a building block in a restore distribution, how to process a building block at restore distribution build time, and how to process a building block at restore time, and storing the rule in a rules data store;
acquiring a constraint concerning one or more of, how to limit a scope of a restore distribution, and when to exclude a building block from a restore distribution, and storing the constraint in a constraint data store; and
building a restore distribution superset from one or more of, the building block, the attribute, the rule, and the constraint, where a restore distribution can be built from a subset of the elements of the restore distribution superset, and where the restore distribution superset is stored in a database.

32. A method, comprising:
accessing a superset of restore distribution elements;
determining a desired coverage for a restore distribution to be built from one or more restore distribution elements;
selectively reading, from the superset, a building block, where the reading is controlled, at least in part, by the desired coverage;
reading, from the superset, an attribute concerning the building block;
reading, from the superset, a rule concerning one or more of, how to process the building block into the restore distribution, and how to process the building block at restore time;
acquiring a constraint concerning how the building block is to be limited in a software image built on a target platform from the restore distribution;
building a restore distribution comprising one or more building blocks and one or more computer executable instructions, where the software image can be built on the target platform from the restore distribution; and
controlling a media creator to store the restore distribution on a computer-readable medium.

33. The method of claim 32, where a building block comprises one or more of, a file, a program, an application, an object, a dynamic link library, a data structure definition, a data structure, a file system definition, a file system, an applet, a servlet, a subroutine, a database record, and a database.

34. The method of claim 32, where an attribute is configured to store information concerning one or more of, an operating system associated with a building block, an operating system version associated with a building block, a spoken language associated with a building block, a computer language associated with a building block, a geographic region in which a building block may function, a device identifier for a device with which a building block may function, a release data associated with a building block, an architecture with which a building block may function, a build list, an interaction between two or more building blocks, a desired interaction between two or more building blocks, and a dependency between two or more building blocks.

35. The method of claim 32, where a rule describes one or more of, how a building block is to be selected for inclusion in a restore distribution, how to combine two or more building blocks, how to connect two or more building blocks, when a building block is to be processed at restore distribution build time, how a building block is to be processed at restore distribution build time, when a building block is to be processed at restore time, and how a building block is to be processed at restore time.

36. The method of claim 32, where a constraint describes one or more of, how to limit the scope of a restore distribution, and when to exclude a building block from a restore distribution.

37. The method of claim 32, where the superset is stored in a database.

38. The method of claim 32, including receiving, from the computer-readable media creator, a tracking data concerning storing the restore distribution on the computer-readable medium, and storing the tracking data.

39. A system, comprising:
means for acquiring a restore distribution content and computer executable instructions for manipulating the restore distribution content, where a restore distribution can be built from the restore distribution content by executing the instructions;
means for building the restore distribution from the restore distribution content by executing the instructions; and
means for storing the restore distribution on a computer-readable medium.

40. In a computer system having a graphical user interface comprising a display and a selection device, a method of providing and selecting from a set of data entries on the display, the method comprising:
retrieving a set of data entries, where a data entry represents a restore distribution build operation;
displaying the set of data entries on the display;
receiving a data entry selection signal indicative of the selection device selecting a selected data entry; and
in response to the data entry selection signal, initiating a restore distribution build operation associated with the selected data entry.

41. A computer-readable medium having stored thereon a data structure comprising:
a first field containing a building block that may be included in a restore distribution;
a second field containing attribute data concerning the building block; and
a third field containing a rule concerning whether to include the building block in the restore distribution, how to process the building block into the restore distribution, and how to process the building block out of the restore distribution into a software image.

42. A set of application programming interfaces embodied on a computer-readable medium for execution by a logic in conjunction with building a restore distribution, comprising:
a first interface for communicating a building block that may be included in the restore distribution;
a second interface for communicating an attribute data concerning the building block; and
a third interface for communicating a rule concerning one or more of, how to process a building block into a restore distribution, and how to process a building block out of a restore distribution into a software image on a target platform.
